(19) United States
(12) Patent Application Publication
(10) Pub. No.: US 2008/0223305 A1
(43) Pub. Date: Sep. 18, 2008

(54) MULTIMEDIA HABITAT ASSEMBLY

(76) Inventor: Richard K. Bilow, Los Angeles, CA (US)

Correspondence Address: STOEL RIVES LLP - SLC, 201 SOUTH MAIN STREET, ONE UTAH CENTER, SALT LAKE CITY, UT, 84111, US

(21) Appl. No.: 12/130,596

(22) Filed: May 30, 2008

Related U.S. Application Data
(63) Continuation of application No. 11/454,160, filed on Jun. 15, 2006, now abandoned.
Application No. 11/454,160 is a continuation of application No. 11/049,582, filed on Feb. 2, 2005, now abandoned.
(60) Provisional application No. 60/541,196, filed on Feb. 2, 2004.
(60) Provisional application No. 60/541,150, filed on Feb. 2, 2004.

(51) Int. Cl. A01K 63/00

(52) U.S. Cl. 119/253

(57) ABSTRACT

Disclosed are embodiments of habitat assemblies. In one embodiment, the habitat assembly includes confined habitat structure configured to receive and display elements of nature. An image-revealing window is connected with the confined habitat structure, and includes an image display system to allow for visual media to be displayed as a backdrop to the elements of nature being displayed. A viewing window is positioned opposite from the image-revealing window such that the visual media can be seen through the viewing window.

### RELATED APPLICATIONS

This application is a continuation of application Ser. No. 11/454,160, titled “Multimedia Habitat Assembly” and filed on Jun. 15, 2006, which is a continuation of application Ser. No. 11/049,582, titled “Multimedia Habitat Assembly” and filed on Feb. 2, 2005, which claims the benefit under 35 U.S.C. § 119(e) of U.S. Provisional Patent Application No. 60/541,196, filed Feb. 2, 2004, and titled “Technique for Creating the Impression that a Photograph of Nature has Come to Life, and also claims the benefit under 35 U.S.C. § 119(e) of U.S. Provisional Patent Application No. 60/541,150, filed Feb. 2, 2004, and titled “Technique for Creating the Illusion a Defined Viewing Window is Actually a Portal to Nature.” Each of the aforementioned applications are hereby incorporated by reference.

### TECHNICAL FIELD

The present invention relates generally to the field of habitat assemblies for display of elements of nature, such as plant and/or animal life. More specifically, the present invention relates to habitat assemblies with still and/or motion pictures displayed as a backdrop to the elements of nature.

### BRIEF DESCRIPTION OF THE DRAWINGS

FIG. 1 is a perspective view of the components of one embodiment of a habitat assembly.

FIG. 2 is a perspective view of the embodiment shown in FIG. 1 in an assembled state.

FIG. 3 is a perspective view of a second embodiment of a habitat assembly.

FIG. 4 is a side elevation view of a third embodiment of a habitat assembly.

FIG. 5 is a perspective view of the components of a fourth embodiment of a habitat assembly.

FIG. 6 is a side elevation view of the embodiment shown in FIG. 5 in an assembled state.

### DETAILED DESCRIPTION OF PREFERRED EMBODIMENTS

In one embodiment, the invention includes a confined habitat structure, such as a fish tank for example, configured to receive and display elements of nature. An image-revealing window may be connected with the confined habitat structure and may include an image display system to allow for visual media, such as still and/or moving pictures, to be displayed. A viewing window may be positioned opposite from the image-revealing window such that the visual media can be seen through the viewing window. Embodiments of the invention as thus described may therefore provide an impression or illusion that the elements of nature in the confined habitat structure are being displayed in an actual nature scene, whether still or with motion.

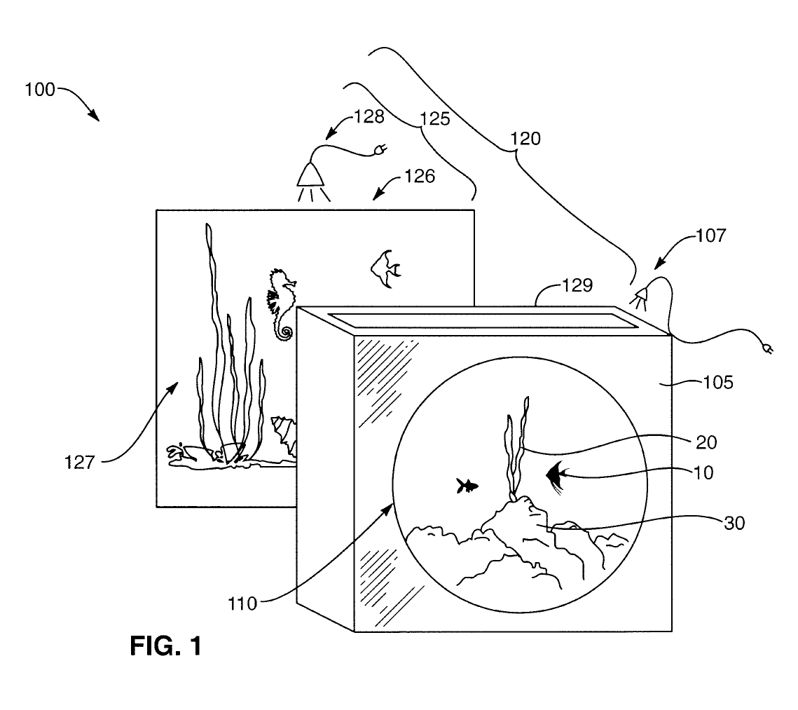

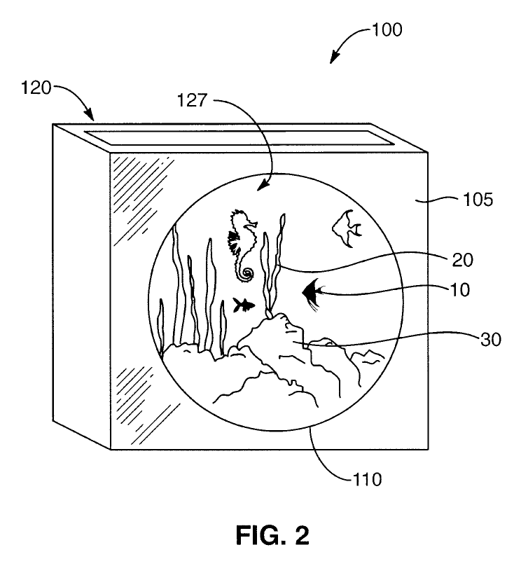

Various representative embodiments of the invention will now be described in greater detail with reference to the accompanying drawings. A first embodiment of the invention is depicted in FIGS. 1-2. In these figures, a habitat assembly 100 is shown. Habitat assembly 100 includes a confined habitat structure 105. Confined habitat structures according to the general principles of the invention may be of any shape and size as desired. Thus, whereas confined habitat structure 105 in FIGS. 1 and 2 is a rectangular solid, other embodiments may include a confined habitat structure which is spherical, semi-spherical, dome-shaped, cylindrical, etc. In the embodiment of FIGS. 1 and 2, the confined habitat structure 105 also includes a habitat light source 107 positioned just above confined habitat structure 105 to illuminate the interior of the structure. Of course, habitat light source 107 could instead be positioned directly inside of the confined habitat structure 105 and still be positioned to illuminate the interior of the confined habitat structure. As should also be apparent, other embodiments are contemplated wherein a habitat light source is not provided.

As can be seen in the figures, confined habitat structure 105 is configured to receive and display elements of nature, such as fish 10, plants 20, and rocks 30. The term “elements of nature” is intended to be construed broadly so as to encompass any of a variety of natural elements or features, such as animal life, plant life, rocks or rock features, etc. Moreover, the term is intended to encompass synthetic elements made to appear as though they were natural, such as artificial plants, rocks, and the like.

The elements of nature are viewable through a viewing window 110, which is positioned opposite from an image-revealing window 120. Viewing window 110 in this embodiment is circular. However, any shape and/or size of viewing window may be provided. Optionally, viewing window 110 may also protrude outward from the confined habitat structure 105 toward the viewer. Note also that viewing window 110 is smaller than image-revealing window 120. Thus, by virtue of having a smaller viewing window than the image-revealing window, habitat assembly 100 is configured to substantially prevent viewing of the interior of the confined habitat structure peripheral to image-revealing window 120. Of course, in other embodiments, the viewing window is not smaller than the image-revealing window. Even in such embodiments, however, the habitat assembly may be configured to substantially prevent viewing of the interior of the confined habitat structure peripheral to the image-revealing window, as discussed later.

Image-revealing window 120 is connected with confined habitat structure 105 and includes an image display system 125. In the embodiment shown in FIGS. 1 and 2, image display system 125 includes a backlit transparency 126 containing a still picture 127. Examples of suitable backlit transparencies include display materials sold under the trademarks DURATRANS® and DURACLEAR™ by Eastman Kodak Company.

Image display system 125 may also include a secondary light source 128 to enhance viewing of the still picture 127, particularly in darker rooms or other such viewing environments. Of course, in some embodiments, the lighting in the display environment from other sources, such as the sun, light bulbs, etc., may be sufficient such that a secondary light source is not important and/or not provided. It should also be understood that the secondary light source may be incorporated into the backlit transparency itself such that it is not a separate component.

In this embodiment, the rear portion 129 of confined habitat structure 105 is part of image-revealing window 120. Still picture 127 is displayed by image-revealing window 120 by virtue of this rear portion 129 being transparent. The backlit transparency 126 may be connected with the rear portion of confined habitat structure 105 by any available methods and/or structures. For example, backlit transparency 126 may be attached with screws, bolts, clamps, adhesive, etc. In alternative embodiments, the backlit transparency need not be attached to the confined habitat structure at all. Instead, the still picture could be merely placed behind the confined habitat structure so as to rest in an upright position, or the backlit transparency could be sandwiched between the habitat structure and a wall or other similar stabilizing structure. In addition, it should be understood that, in still other embodiments, the image-revealing window could be directly incorporated into the confined habitat structure such that no attachment is needed between the two elements.

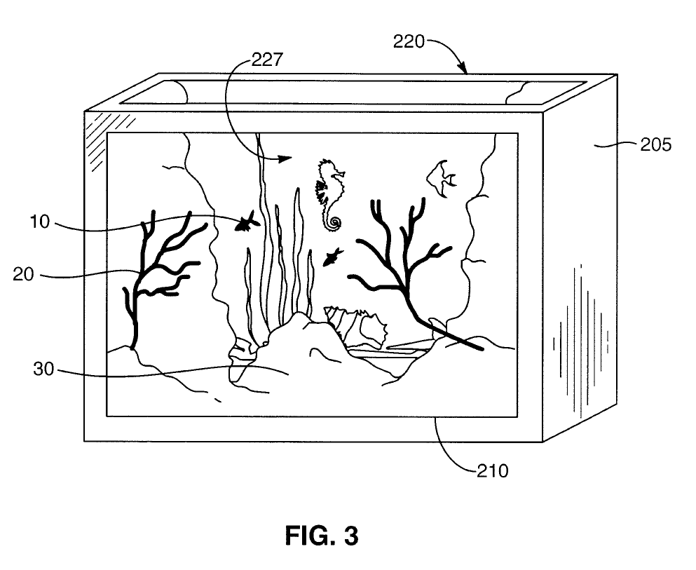

A second embodiment of the invention is shown in FIG. 3. Habitat assembly 200 is similar to habitat assembly 100 in that it includes a confined habitat structure 205, a viewing window 210, and an image-revealing window 220 (which displays picture 227). However, viewing window 210 of habitat assembly 200 is approximately the same size as image-revealing window 220. Nevertheless, habitat assembly 200 is still configured to substantially prevent viewing of the interior of confined habitat structure 205 peripheral to image-revealing window 220. This is because of rock formation 30, which extends along at least a portion of the interior sides and periphery of the rear wall of confined habitat structure 205. Rock formation 30 blocks the sight lines through viewing window 210 to the interior sides and connections seams or forming lines of the confined habitat structure 205.

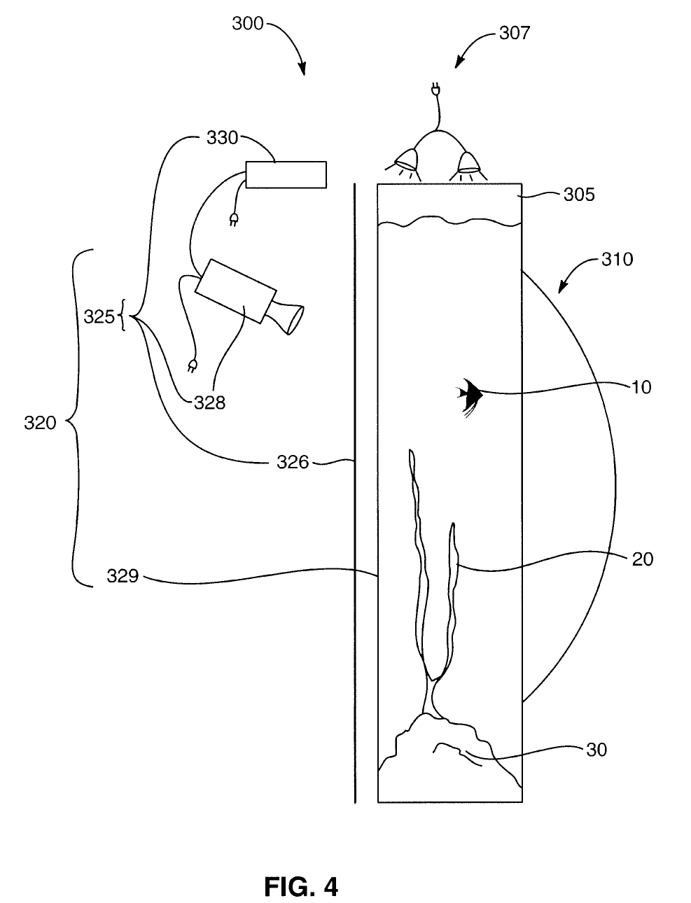

Still another embodiment of the invention is shown in FIG. 4. Habitat assembly 300 is configured to allow for a motion picture to be displayed as a backdrop to the elements of nature contained in the confined habitat structure 305. As can be seen, confined habitat structure 305 includes a viewing window 310 which protrudes outward from the confined habitat structure 305 toward the viewer. Like habitat assembly 200, this embodiment is also configured with a viewing window 310 that is smaller than the image-revealing window 320 so as to substantially prevent viewing of the interior of confined habitat structure 305 peripheral to image-revealing window 320. This embodiment also includes an optional habitat light source 307.

Image-revealing window 320 includes image display system 325, which, in turn, includes display screen 326, projector 328, and DVD player 330. Image-revealing window also includes the rear face 329 of the confined habitat structure, which, like several embodiments mentioned previously, is transparent so as to allow the pictures generated and displayed by image display system 325 to be viewed via viewing window 310.

Those having ordinary skill in the art will appreciate that a wide variety of alternatives may be used. For instance, a television, computer monitor, plasma monitor, LCD monitor, rear-projection system, or the like may be used alone or in combination with a computer hard drive, DVD player, cassette player, projector, computer, computer chip or memory card, cassette tape, film, etc., to comprise the image display system. Additionally, the image display system employed by embodiments of the invention could provide for display of static pictures as well as motion pictures, or for a combination thereof. For example, the system may be configured to alternate between a display of one or more static pictures, followed by one or more motion pictures, etc. Moreover, motion pictures provided for use with embodiments of the invention may be shot or otherwise recorded with equipment having video stabilization features. Examples of suitable video stabilization equipment include camcorders with optical video stabilization or digital stabilization, video stabilization software, or simply a tripod.

The screen, monitor, TV, etc., may be placed adjacent to or be attached to the confined habitat structure 305. Alternatively, as previously discussed with reference to still picture embodiments, motion picture embodiments could also be configured such that the image display system is incorporated directly into the confined habitat structure. In other words, the rear face of the confined habitat structure in such embodiments would, instead of being adjacent to a display screen, be the screen as well. In both still and motion picture embodiments, the picture could comprise any of a variety of, for instance, scenes of nature. In one embodiment in which the confined habitat structure is an aquarium, the picture could be an underwater aquatic scene. In another embodiment, the confined habitat structure could be partially filled with water and the picture could include a beach and/or sky scene. In still other embodiments, some of which do not include a confined habitat structure having water therein at all, the picture could be a forest, jungle, desert, or other such scene of nature.

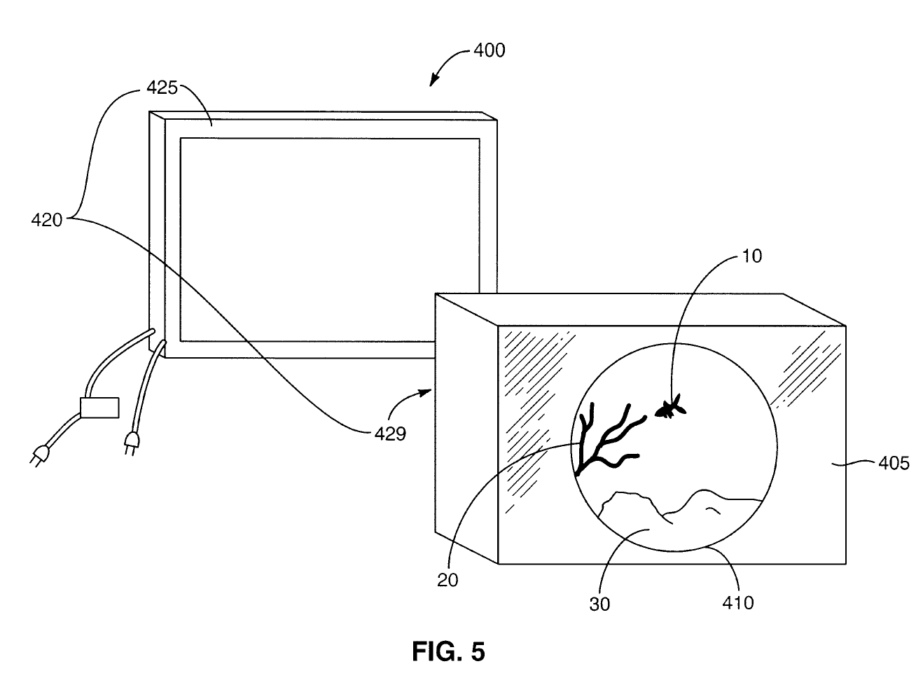

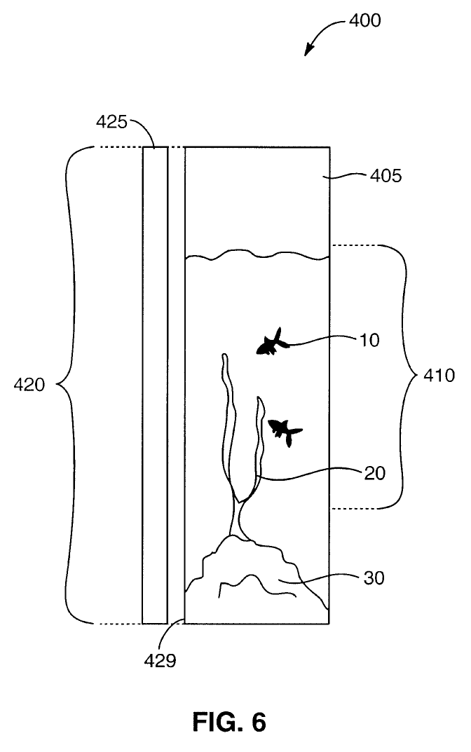

Yet another embodiment of the invention is shown in FIGS. 5 and 6. In this embodiment, habitat assembly 400 includes a confined habitat structure 405, which has a viewing window 410 formed therein. Once again the image-revealing window 420 includes both an image display system 425 and the rear face of the confined habitat structure 405. In this embodiment, image display system 425 comprises a flat-panel monitor, which may be connected with a computer or other input device. As seen in the figures, viewing window 410 is smaller than image-revealing window 420. Likewise, viewing window 410 is smaller than the visual media display provided by the image display system 425.

The above description fully discloses the invention including preferred embodiments thereof. Without further elaboration, it is believed that one skilled in the art can use the preceding description to utilize the invention to its fullest extent. Therefore, the examples and embodiments disclosed herein are to be construed as merely illustrative and not a limitation of the scope of the present invention in any way.

It will be obvious to those having skill in the art that many changes may be made to the details of the above-described embodiments without departing from the underlying principles of the invention. The scope of the present invention should, therefore, be determined only by the following claims.

1. A habitat assembly, comprising:
a confined habitat structure configured to receive and display elements of nature;
an image-revealing window connected with the confined habitat structure, wherein the image-revealing window comprises a motion picture display system; and
a viewing window positioned opposite from the image-revealing window, wherein the image-revealing window is configured to display a motion picture comprising a sequence of images giving the illusion of continuous movement, wherein the motion picture can be seen through the viewing window, and wherein the habitat assembly is configured to substantially prevent viewing of the periphery of the image-revealing window at least in part by substantially covering at least a majority of the periphery of the image-revealing window with one or more synthetic elements made to appear as though they were natural, such that an observer looking through the viewing window perceives only the image-revealing window, the one or more synthetic elements, and the elements of nature.

2. The habitat assembly of claim 1, further comprising a light source positioned to illuminate the interior of the confined habitat structure.

3. The habitat assembly of claim 1, wherein the motion picture display system comprises a monitor.

4. The habitat assembly of claim 1, wherein the elements of nature comprise at least one of animals, plants, synthetic plants, rocks, and synthetic rocks.

5. The habitat assembly of claim 1, wherein the viewing window is substantially circular.

6. The habitat assembly of claim 1, wherein the viewing window protrudes outward from the confined habitat structure toward the observer.

7. The habitat assembly of claim 1, wherein the one or more synthetic elements comprise at least one of artificial plants and artificial rock formations.

8. A habitat assembly, comprising:
an aquarium configured to receive and display elements of nature;
an image-revealing window connected with the aquarium, wherein the image-revealing window comprises a motion picture image display system; and
a viewing window positioned opposite from the image-revealing window, wherein the image-revealing window is configured to display a motion picture comprising a sequence of images giving the illusion of continuous movement, wherein the motion picture can be seen through the viewing window, and wherein the habitat assembly is configured to substantially prevent viewing of at least two sides of the periphery of the image-revealing window at least in part by substantially covering the at least two sides of the periphery of the image-revealing window with one or more synthetic elements made to appear as though they were natural, such that an observer looking through the viewing window perceives the one or more synthetic elements rather than the periphery of the image-revealing window.

9. A method for displaying elements of nature against a visual media backdrop, comprising:
providing a confined habitat structure;
placing at least one element of nature in the confined habitat structure for display;
displaying a visual media behind the confined habitat structure such that the visual media can be seen through a viewing window positioned opposite from the visual media display, wherein the visual media comprises a motion picture made up of a sequence of images giving the illusion of continuous movement; and
substantially covering the periphery of the visual media along at least opposing sides of the visual media with one or more non-moving elements of nature comprising at least one of plants, synthetic plants, rocks, and synthetic rocks, such that an observer looking through the viewing window perceives the one or more non-moving elements of nature in place of a boundary of the visual media along the opposing sides of the visual media.

10. The method of claim 9, further comprising at least partially filling the confined habitat structure with water.

11. The method of claim 9, wherein the at least one element of nature placed in the confined habitat structure for display comprises at least one of animals, plants, synthetic plants, rocks, and synthetic rocks.

12. The method of claim 9, further comprising illuminating the interior of the confined habitat structure with a light source.

13. The method of claim 9, wherein the visual media comprises a combination of still picture and motion picture.

14. The method of claim 9, further comprising the step of recording the motion picture with video stabilization equipment.

15. The method of claim 9, wherein the viewing window is smaller than the visual media display.
